(19) United States
(12) Patent Application Publication
(10) Pub. No.: US 2025/0318685 A1
(43) Pub. Date: Oct. 16, 2025

(54) USER INTERFACE DEVICE FOR COOKING ROBOT, AND COOKING ROBOT CONTROL METHOD USING SAME

(71) Applicants: NEUROMEKA CO., LTD., Seoul (KR); KYOCHON F&B CO., LTD., Chilgok-gun (KR)

(72) Inventors: Tae Jung KIM, Seoul (KR); Young Jin HEO, Seoul (KR); Jong Hoon PARK, Namyangju-si (KR)

(21) Appl. No.: 18/866,034

(22) PCT Filed: May 16, 2023
(86) PCT No.: PCT/KR2023/006579

§ 371 Date: Nov. 14, 2024

(30) Foreign Application Priority Data
May 17, 2022 (KR) 10-2022-0060272

(51) Int. Cl. A47J 37/12; B25J 11/00; B25J 13/06; G06F 3/04842; G06F 3/0488

(52) U.S. Cl. CPC A47J 37/1266; A47J 37/1271; B25J 13/06; G06F 3/04842; G06F 3/0488; B25J 11/0045

(57) ABSTRACT

A user interface device for a cooking robot according to the present invention comprises: a user interface generating unit for generating a primary UI, a secondary UI, and a cleaning UI; a touch screen for displaying the primary UI, the secondary UI, and the cleaning UI and receiving a user's touch input signal such that at least one of the primary UI, the secondary UI, and the cleaning UI is executed; and a control unit for displaying at least one of a primary frying process status to be displayed on the primary UI, a secondary process status to be displayed on the secondary UI, and a cleaning process status to be displayed on the cleaning UI, on the basis of a user's touch input signal input to the touch screen, and outputting a control signal for an operation command of the corresponding cooking robot.

### TECHNICAL FIELD

The present disclosure relates to a user interface device for a cooking robot and a cooking robot control method using the user interface device and, in more detail, to a user interface device for a cooking robot that controls a cooking robot, which performs a frying process of a food material, through a user interface device, and a cooking robot control method using the user interface device.

### BACKGROUND

Robots are currently widely used in various industrial fields and the usability of the robots is also increasing. For example, robots are classified into an industrial robot, a collaborative robot, etc. Industrial robots are robots that replace human in production environments to perform dangerous and difficult tasks and they are deployed and used in workspaces separated from humans. Collaborative robots, unlike industrial robots, complement humans by working alongside them to enhance work efficiency.

Recently, with the active development of robot-related technologies for non- face-to-face services, the use of collaborative robots that work alongside humans and perform tasks that complement humans is increasing. For example, collaborative robots play a role in the food service industry by providing food to consumers and complementing humans in the cooking space by performing simple, repetitive, and dangerous tasks.

Collaborative robots that are used in the food service industry are used as cooking robots that fry food materials such as a chicken using oil. Cooking robots not only can prevent the dangers that may influence humans due to high-temperature oil in a frying process of food materials, but can prevent musculoskeletal disorders of humans by performing a simple and repetitive frying process.

Meanwhile, cooking robots that are used in a frying process fundamentally perform a process of frying food materials by loading and unloading a basket into and out of a fryer. Users use a user interface device to provide work instructions to cooking robots. A user interface (UI) related to work instructions for cooking robots to load a basket into a fry and unload the basket from the fryer to discharge the cooked food materials after a predetermined time passes is created in user interface devices, and users provide work instructions to the cooking robots using the created user interface.

However, since only a user interface for a frying process of food materials is generally created in user interface devices that provide work instructions to cooking robots in the related art, there is an increasing need for various interfaces that can recognize more detailed frying process and frying process status.

### DISCLOSURE

### Technical Problem

An objective of the present disclosure is to provide a user interface device for a cooking robot in which not only a user interface related to a frying process for a cooking robot, but a user interface that can provide various work instructions to a cooking robot is created, and a cooling robot control method using the user interface device.

### Technical Solution

The objectives are achieved by a user interface device for a cooking robot that provides work instructions for frying food materials using a basket in a fryer accommodating oil to the cooking robot while communication with the cooking robot, the user interface device including: a user interface creator creating a primary UI related to a primary frying process of food materials, a secondary UI related to secondary frying process of the food materials, and a cleaning UI related to cleaning of the fryer; a touch screen displaying the primary UI, the secondary UI, and the cleaning UI and receives a user's touch input signal to execute at least any one of the primary UI, the secondary UI, and the cleaning UI; and a controller displaying at least any one of a primary frying process state to be displayed on the primary UI, a secondary process state to be displayed on the secondary UI, and a cleaning process state to be displayed on the cleaning UI, and outputting a control signal about a corresponding work instruction of the cooking robot on the basis of a user's touch input signal input to the touch screen.

In this configuration, the cleaning UI may be disposed at each of the primary UI and the secondary UI in correspondence to the primary UI and the secondary UI.

The cleaning UI may include: a cleaning ON-UI providing a cleaning mode for unloading the basket out of the fryer to the cooking robot on the basis of a user's touch input signal; and a cleaning OFF-UI providing a cleaning stop mode for moving the basket into a frying process ready step to the cooking robot on the basis of a user's touch input signal.

When the cleaning ON-UI is activated, a user may remove floats floating in the fryer.

The secondary UI may include: a main UI displaying the kind of food materials and a frying time state on the basis of a user's touch input signal; and an assistant UI making the cooking robot shake the basket in a frying process of food materials on the basis of a user's touch input signal.

When the assistant UI is activated, the cooking robot may perform an operation of shaking the basket in the fryer so that uniform temperature of oil is provided to food materials.

A plurality of secondary UIs may be created and displayed on the touch screen, and the secondary basket may be sequentially shaken in a secondary frying process of food materials in accordance with the activation order of the plurality of assistant UIs.

Meanwhile, the objectives may be achieved also by a cooking robot control method using a user interface device for a cooking robot, the cooking robot control method including: (a) a step of providing a touch input signal by a user to at least any one of a primary UI and a secondary UI created in the user interface device for a cooking robot; (b) a step of displaying a state of at least any one of the primary UI and the secondary UI on the user interface device for a cooking robot and creating a corresponding work instruction of the cooking robot on the basis of a user's touch input signal in the step (a); (c) a step in which the user provides a touch input signal to a cleaning UI created on the user interface device for a cooking robot after the step (b) is finished; and (d) a step in which the cooking robot unloads a basket out of a fryer so that the user removes floats floating in the fryer in accordance with the step (c).

In this configuration, the cleaning UI may include: a cleaning ON-UI providing a cleaning mode for unloading the basket out of the fryer to the cooking robot on the basis of a user's touch input signal; and a cleaning OFF-UI providing a cleaning stop mode for moving the basket into a frying process ready step to the cooking robot on the basis of a user's touch input signal.

The cleaning UI may be disposed in relation to the primary UI and the secondary UI in correspondence to the primary UI and the secondary UI.

The secondary UI may include a main UI displaying the kind of food materials and a frying time state and an assistant UI making the cooking robot shake the basket in a frying process of food materials, and when the user provides a touch input signal to the assistant UI after the user provides a touch input signal to the main UI in the step (a), the cooking robot may provide uniform temperature of oil to food materials by shaking the basket accommodating the food materials.

A plurality of secondary UIs may be created and the cooking robot sequentially may shake the corresponding secondary basket in a secondary frying process of food materials in accordance with the activation order of the plurality of assistant UIs.

The details of other example embodiments are included in the following detailed description and the accompanying drawings.

### Advantageous Effects

The effects of the user interface device for a cooking robot according to the present disclosure and a cooking robot control method using the user interface device are as follows.

First, since not only UIs for frying, but the cleaning UI for cleaning a fryer are provided to the user interface device that provides work instructions to the cooking robot, it is possible to reduce the takt time of the frying process of food materials.

Second, since the user interface device that provides work instructions to the cooking robot is provided with not only UIs for frying, but a UI performing an operation making the cooking robot shake a basket to uniformly cook food materials during the frying process, it is possible to improve reliability in the frying process of food materials.

### DESCRIPTION OF DRAWINGS

FIG. 1 is a perspective view of a cooking robot system according to an embodiment of the present disclosure.

FIG. 2 is a control block diagram of the cooking robot system shown in FIG. 1.

FIG. 3 is a configuration diagram of a first user interface of a user interface device for a cooking robot according to an embodiment of the present disclosure.

FIG. 4 is a configuration diagram of a second user interface of a user interface device for a cooking robot according to an embodiment of the present disclosure.

FIG. 5 is a first operation view of the user interface device for a cooking robot shown in FIG. 3.

FIG. 6 is an operation front view of the cooking robot according to FIG. 5.

FIG. 7 is a second operation view of the user interface device for a cooking robot shown in FIG. 3.

FIG. 8 is an operation plane view of the cooking robot according to FIG. 7.

FIG. 9 is a control flowchart of a cooking robot using the user interface device for a cooking robot according to a first embodiment of the present disclosure.

FIG. 10 is a control flowchart of a cooking robot using the user interface device for a cooking robot according to a second embodiment of the present disclosure.

### MODE FOR DISCLOSURE

Hereafter, a user interface device for a cooking robot according to an embodiment of the present disclosure and a cooking robot control method using the user interface device are described in detail with reference to the accompanying drawings.

Before describing, it should be noted that the figures related to the user interface device for a cooking robot according to an embodiment of the present disclosure and the cooking robot control method using the user interface device show frying of a chicken, but the present disclosure is not limited thereto and the present disclosure can be used for processes of frying various food materials.

Further, it should be noted that the same components are given the same reference numerals in the user interface device for a cooking robot according to first and second embodiments of the present disclosure and the cooking robot control method using the user interface device.

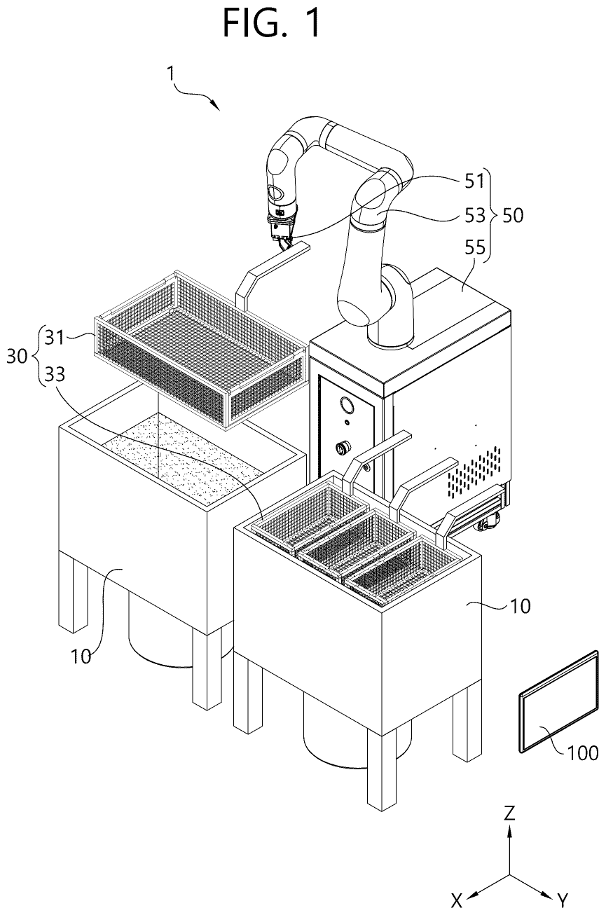

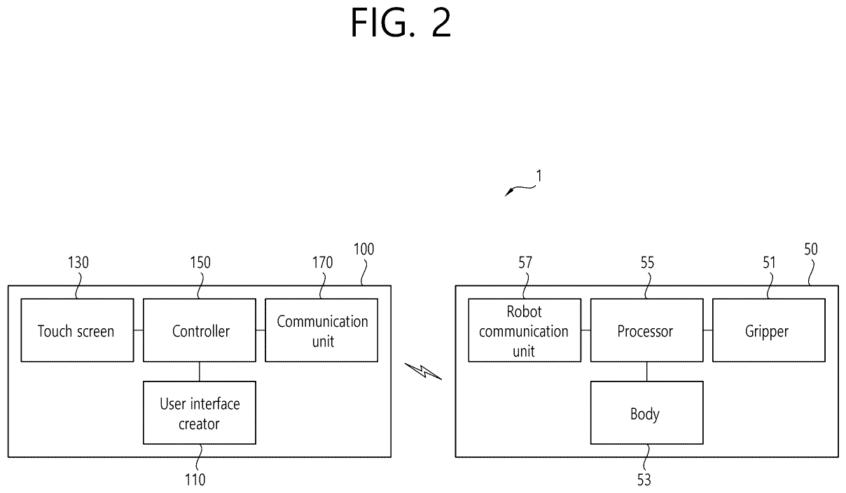

FIG. 1 is a perspective view of a cooking robot system according to an embodiment of the present disclosure and FIG. 2 is a control block diagram of the cooking robot system shown in FIG. 1.

As shown in FIG. 1 and FIG. 2, a cooking robot system 1 includes a fryer 10, a basket 30, a cooking robot 50, and a user interface device 100 for the cooking robot 50 (hereafter, referred to as a user interface device).

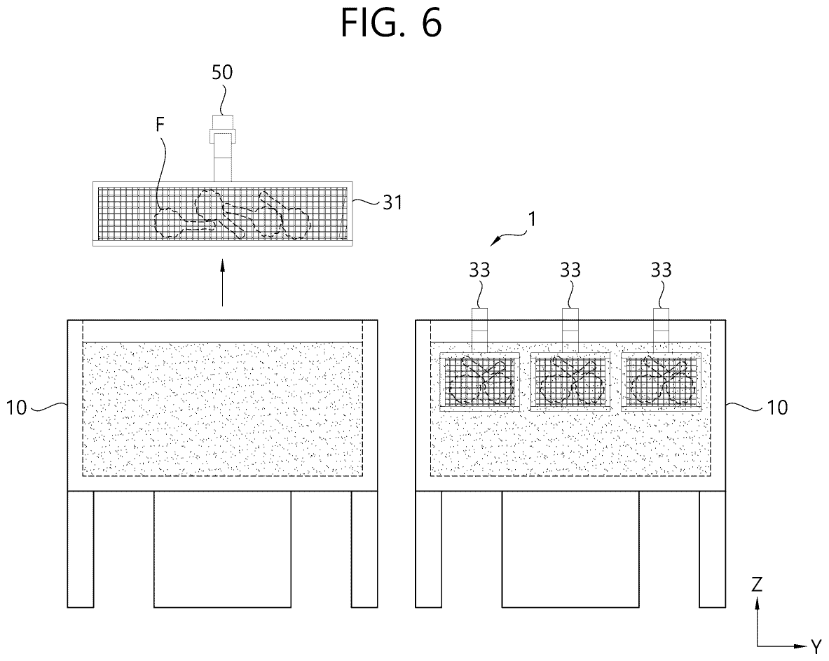

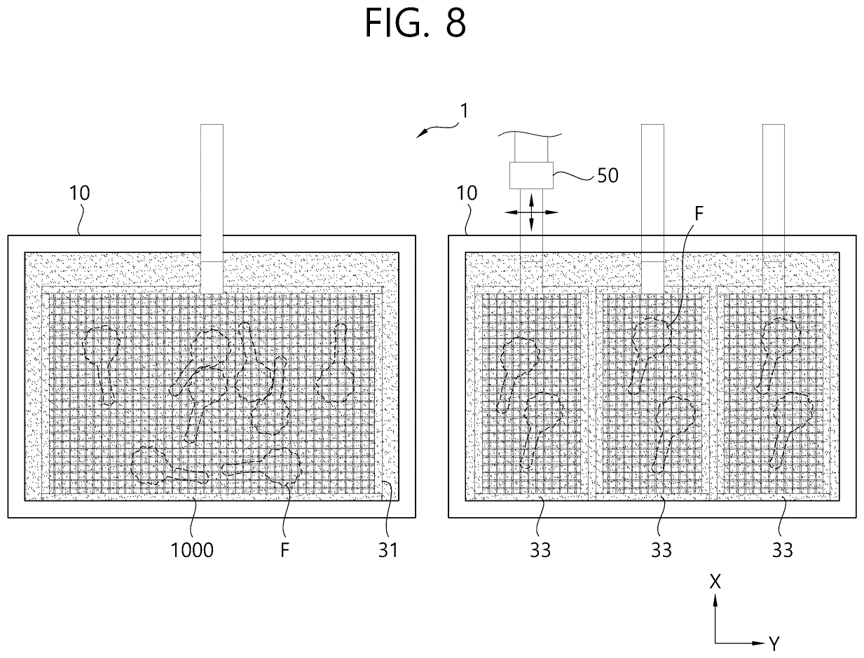

The fryer 10 stores oil for frying food materials F (see FIG. 6 and FIG. 8). As an embodiment of the present disclosure, the fryer 10 includes a fryer 10 for primarily frying food materials F and a fryer 10 for secondarily frying the primarily fried food materials F. Fryers 10 exceeding two may be disposed, unlike an embodiment of the present disclosure, depending on the disposition space. The fryer 10 forms an accommodation space accommodating oil and includes a heating unit heating the oil not shown. Although not shown in the present disclosure, a fry storage container that stores fried food materials F from the fryer 10 is disposed in a cooking space.

The basket 30 forms a food material accommodation space accommodating food materials F and is formed in a mesh structure so that it can be loaded and unloaded into and out of the accommodation space accommodating oil. Food materials F may be put into basket 30 and then loaded into the fryer 10 by the cooking robot 10 or may be put into the basket 30 after the basket 30 is loaded into the fryer 10 by the cooking robot 50. Processes of loading, unloading, and shaking the basket 30 in the fryer 10 are performed by the cooking robot 50. As an embodiment of the present disclosure, the basket 30 includes a primary basket 31 and a secondary basket 33.

The primary basket 31 has a size corresponding to the area of the entrance through which the primary basket 31 is loaded and unloaded into and out of the fryer 10. The primary basket 31 is used to primarily fry food materials F coated with batter, etc. in oil.

The secondary basket 33 is used to secondarily fry the food materials F primarily fried by the primary basket 31. The secondary basket 33 has a size smaller than the size of the primary basket 31. As an embodiment of the present disclosure, three secondary baskets 33 are loaded and unloaded into and out of one fryer 10, but secondary baskets 33 less than three or exceeding three may be used, depending on the size of the fryer 10 and the sizes of the secondary baskets 33.

The cooking robot 50 performs processes of moving the basket 30 accommodating food materials F or the basket 30 to the fryer 10, loading and unloading the basket 30 into and out of the fryer 10, moving the basket 30 unloaded out of the fryer 10 or moving the basket 30 to the fry storage container, and discharging the cooked food materials into the fry storage container by rotating the basket 30. Further, when a touch input signal is provided to a cleaning UI 115 of the user interface device 100 to be described below, the cooking robot 50 unloads the basket 30 out of the fryer 10 so that a user can clean the fryer 10. Further, when a touch input signal is provided to an assistant UI 113b of a secondary UI 113 of the user interface device 100 to be described below, the cooking robot 50 performs an operation of shaking the secondary basket 33 loaded in the fryer 10.

As an embodiment of the present disclosure, the cooking robot 50 includes a gripper 51, a body 3, a processor 55, and a robot communication unit 57. The gripper 51 holds the basket 30. The gripper 51 selectively holds the basket 30 in accordance with a work instruction provided from the user interface device 100. A tolerance enabling relative rotation between the gripper 51 and the basket 30 when the gripper 51 holds the basket 30 is set, so the gripper 51 absorbs the shock generated between the fryer 10 and the basket 30. On the contrary, when a tolerance enabling relative rotation between the gripper 51 and the basket 30 is not set, the operation of the cooking robot 50 may be stopped by the shock transmitted from the basket 30.

The gripper 51 is disposed at the end of the body 53 and the body 130 has a plurality of multi-joint arms. The body 53 selectively moves, moves up and down, and rotates the basket 30 held by the gripper 51. In detail, the body 53, after the basket 30 is held by the gripper 51, moves the basket 30 to the fryer 10, loads and unloads the basket 30 into and out of the fryer 10, moves the basket 30 to the fry storage container, and then rotates the basket 30 to discharge the food materials F accommodated in the basket 30 to the fry storage container. Further, the body 53 operates to shake the secondary basket 33 in the fryer 10 during a secondary frying process.

The processor 55 creates work instructions for the gripper 51 and the body 53. The processor 55 substantially work instructions received through the robot communication unit 57 as control signals for operating the gripper 51 and the body 53. The processor 55, as an embodiment of the present disclosure, creates work instructions for the gripper 51 and the body 53 using a multi-thread. For example, the processor 150 uses a multi-thread including a plurality of threads such as a thread that determines work with the highest priority by determining priorities between a plurality of items of work, a thread that checks the state information of the gripper 51 and the body 53, and a thread that receives instruction information that is generated from the user interface device 100. The processor 55 outputs work instructions for performing a frying process using the cooking robot 50 according to an embodiment of the present disclosure. The processor 55 outputs work instructions for cleaning the fryer 10 and shaking the secondary basket 33 in accordance with work instructions provided from the user interface device 100.

The robot communication unit 57 is configured to receive work instructions transmitted from the user interface device 100. The robot communication unit 57 provides received work instructions to the processor 55 by wirelessly communicating with a communication unit 170 of the user interface device 100 to be described below. Further, the robot communication unit 57 transmits feedback on operations of the gripper 51 and the body 53 to the user interface device 100.

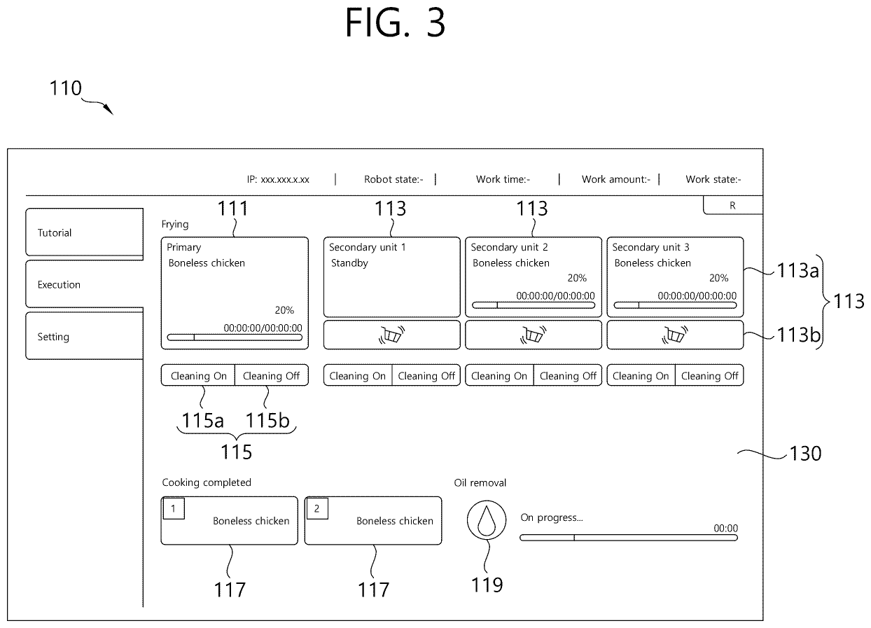

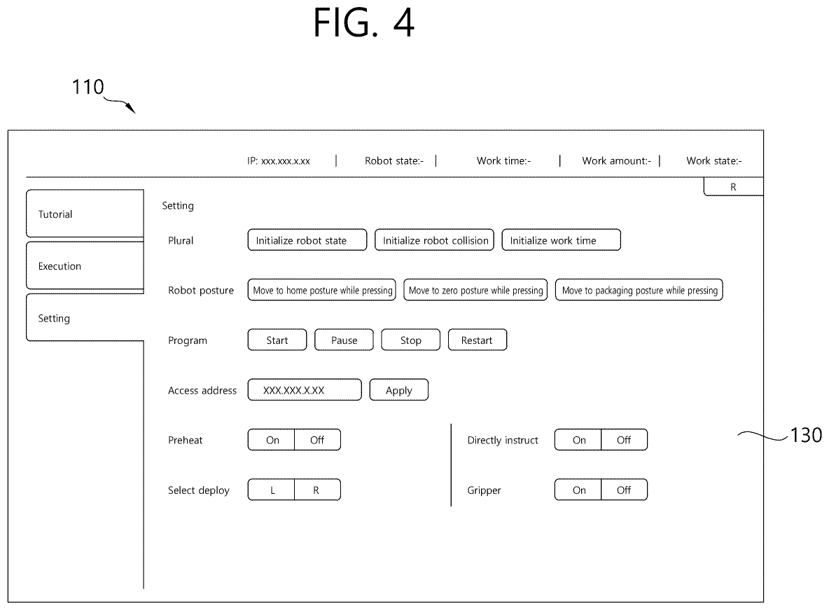

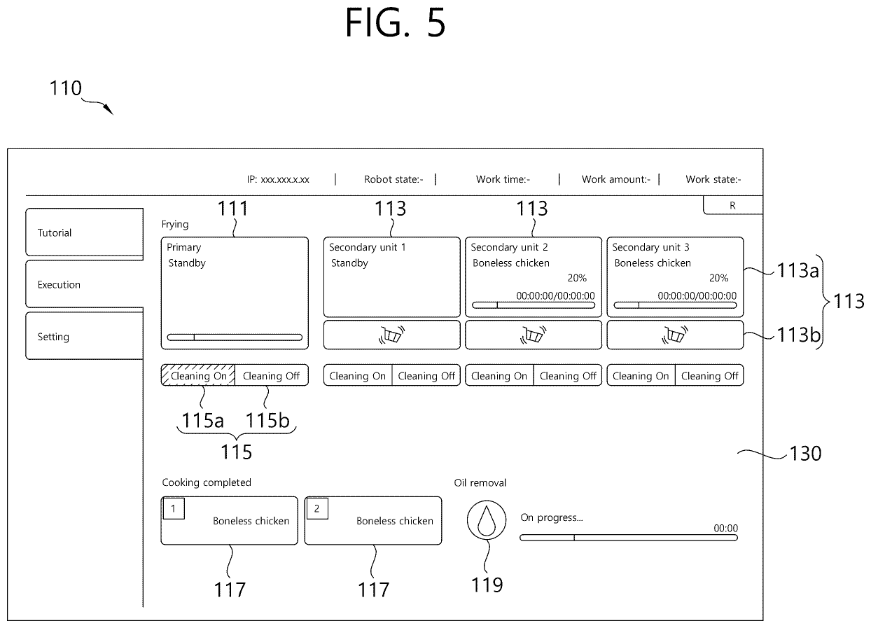

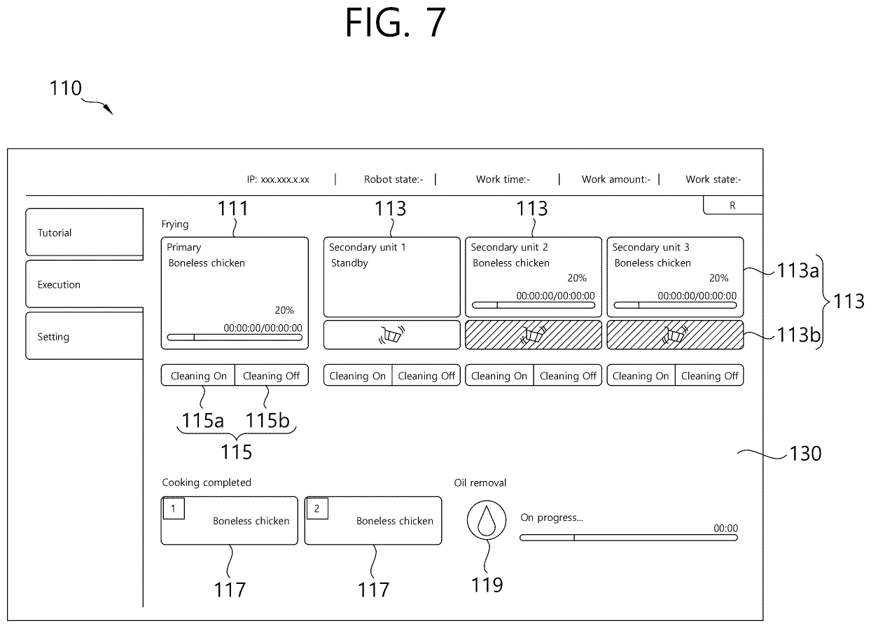

FIG. 3 is a configuration diagram of a first user interface of a user interface device for a cooking robot according to an embodiment of the present disclosure, FIG. 4 is a configuration diagram of a second user interface of a user interface device for a cooking robot according to an embodiment of the present disclosure, FIG. 5 is a first operation view of the user interface device for a cooking robot shown in FIG. 3, FIG. 6 is an operation front view of the cooking robot according to FIG. 5, FIG. 7 is a second operation view of the user interface device for a cooking robot shown in FIG. 3, and FIG. 8 is an operation plane view of the cooking robot according to FIG. 7.

The user interface device 100, as shown in FIG. 3 to FIG. 8, includes a user interface creator 110, a touch screen 130, and a controller 150. Further, the user interface device 100 further includes a communication unit 170. The user interface device 100, as an embodiment of the present disclosure, has a tablet PC shape, but is not limited thereto and may be used as a portable device such as a smartphone. The user interface device 100 provides work instructions for operating the cooking robot 50 to the cooking robot 50.

The user interface device 100, as an embodiment of the present disclosure, includes a tutorial tab, an execution tab, and a setting tab. The tutorial tab shows a video about the operation of the cooking robot 50 to a user. The execution tab, as shown in FIG. 3 to FIG. 5, and FIG. 7, has a plurality of UIs for providing work instructions to the cooking robot 50. The setting tab, as shown in FIG. 4, has a plurality of UIs for setting the operation of the cooking robot 50. For example, as shown in FIG. 4, the setting tab has various UIs for setting the cooking robot 50 such as initialization of collision of the cooking robot 50, selection of deploy, and ON/OFF of operation of the gripper 51.

The user interface creator 110 creates a primary UI 111, a secondary UI 113, and a cleaning UI 115 of the execution tab. Further, the user interface creator 110 creates cooking completion UI 117 and an oil removal UI 119. The user interface creator 110 is also involved with creation of UI of the setting tap other than the execution tab.

The primary UI 111 is created to primarily fry food materials F using the primary basket 31. When a touch input signal is provided from a user, the primary UI 111 provides a work instruction to the cooking robot 50 through the robot communication unit 57 and displays a cooking state that shows the food materials F that are being primarily fried, and the elapsed time and completion time of cooking.

The secondary UI 113 is created to secondarily fry food materials F using the secondary basket 33. Three secondary UIs 113, as an embodiment of the present disclosure are created in correspondence to three secondary baskets 33. Of course, the secondary UI 113 is created in correspondence to the number of the secondary basket 33. The secondary UI 113 includes a main UI 113a and an assistant UI 113b.

The main UI 113a not only displays the kind of food materials F and a frying time state, but provides corresponding work instructions to the cooking robot 50 on the basis of a user's touch input signal. The assistant UI 113b is activated so that the cooking robot 50 shakes the basket 3 in a frying process of food materials F, and provides a corresponding work instruction to the cooking robot 50 so that the cooking robot 50 performs the process of shaking the basket 30 on the basis of a user's touch input signal. In this case, when the assistant UI 113b is activated, the cooking robot 50 performs the operation of shaking the secondary basket 33 in the fryer 10 so that uniform temperature of oil is provided to the food materials F. In more detail, a plurality of assistant UIs 113b is created in correspondence to a plurality of secondary UIs 113, and a work instruction is provided to the cooking robot 50 to perform a process of sequentially shaking the secondary basket 33 in accordance with touch input signals sequentially provided to the plurality of assistant UIs 113b.

The cleaning UI 115 is created such that the operation of the cooking robot 50 about cleaning of the fryer 10 is performed. The cleaning UI 115 is created in correspondence to the primary UI 111 and the secondary UI 113. The cleaning UI 115 includes a cleaning ON-UI 115a and cleaning OFF-UI 115b. The cleaning ON-UI 115a provides a cleaning mode for unloading the basket 30 out of the fryer 10 to the cooking robot 50 on the basis of a user's touch input signal. The cleaning OFF-UI 115b provides a cleaning stop mode for moving the basket 30 into a frying process ready step to the cooking robot 50 on the basis of a user's touch input signal. In this case, when the cleaning ON-UI 115a is activated, a user removes floats floating in the fryer 10. For example, a user, in order to remove fry floats floating in the fryer 10, provides a touch input signal to the cleaning ON-UI 115a, and correspondingly, the cooking robot 50 unloads the basket 30 out of the fryer 10.

The cooking completion UI 117 is created to display the kind of cooked food materials F and completion of cooking. The oil removal UI 119 is created to display the progression state of oil removal in an oil removal process of food materials F. When the oil removal UI 119 is activated, the cooking robot 50 performs the oil removal process of food materials F.

The touch screen 130 displays the primary UI 111, the secondary UI 113, and the cleaning UI 115 and receives a user's touch input signal to execute at least any one of the primary UI 111, the secondary UI 113, and the cleaning UI 115. Further, the touch screen 130 displays the main UI 113a and the assistant UI 113b of the primary UI 113 and receives a touch input signal from a user. The touch screen 130 displays the cooking completion UI 117 and displays the oil removal UI 119 for the oil removal process. The touch screen 130 displays a plurality of UIs created by the user interface creator 110 and receives user's touch input signals for the plurality of displayed UIs.

The controller 150 displays at least any one of a primary frying process state to be displayed on the primary UI 111, a secondary process state to be displayed on the secondary UI 113, and a cleaning process state to be displayed on the cleaning UI 115, and outputs a control signal about the corresponding work instruction of the cooking robot 50 on the basis of a user's touch input signal input to the touch screen 130. The controller 150 outputs control signals to provide various work instructions, such as a primary frying process, a secondary frying process, a cleaning process, and a shaking process, to the cooking robot 50 and displays the states of the touched UIs on the basis of user's touch input signals input to the touch screen 130.

The communication unit 170 communicates with the robot communication unit 57 to provide work instructions of corresponding UIs to the cooking robot 50 on the basis of user's touch input signals input to the touch screen 130. Further, communication unit 170 receives feedback signals from the robot communication unit 57 to display the state of the cooking robot 50 on the user interface device 100.

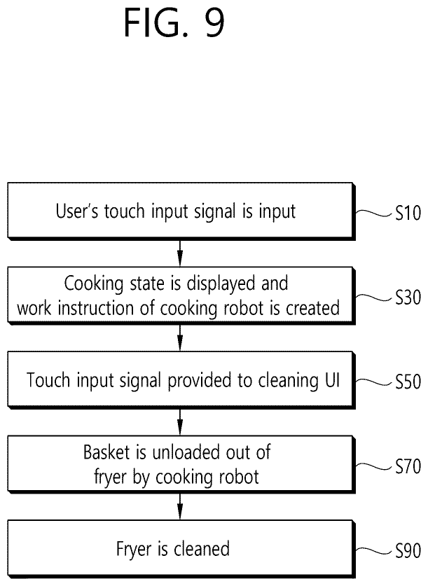

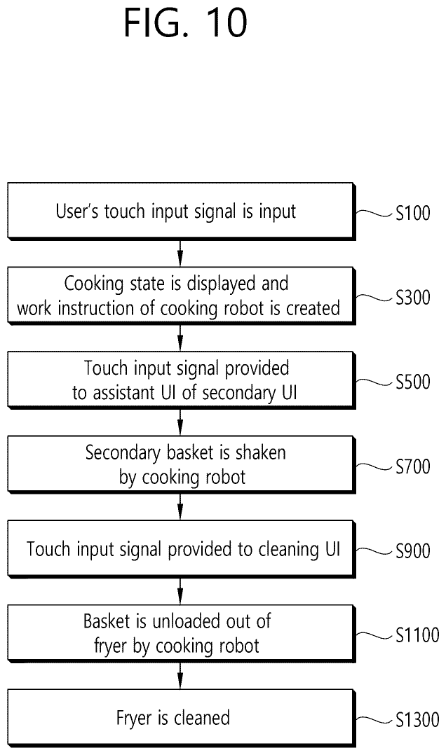

Next, FIG. 9 is a control flowchart of a cooking robot using the user interface device for a cooking robot according to a first embodiment of the present disclosure and FIG. 10 is a control flowchart of a cooking robot using the user interface device for a cooking robot according to a second embodiment of the present disclosure.

As shown in FIG. 9, a cooking robot 50 control method using the user interface device 100 for the cooking robot 50 according to a first embodiment of the present disclosure relates to a frying process of food materials F and a cleaning process of the fryer 10 using the cooking robot 50.

First, a touch signal for providing a work instruction to the cooking robot 50 is input through the touch screen 130 (S10). In touch signal input in step S10, a user inputs a touch input signal to at least any one of the primary UI 111 and the secondary UI 113 created on the user interface device 100. For example, a touch input signal is provided to any one of the primary UI 111 and the secondary UI 113, a touch input signal is provided to the primary UI 111 and the secondary UI 113, a touch input signal is provided to a plurality of secondary UIs 113, or a touch input signal is provided to at least any one of a plurality of secondary UIs 113.

In accordance with the user's touch input signal, a cooking state is displayed and a work instruction of the cooking robot 50 is created (S30). As shown in FIG. 3, when a user inputs a touch signal to the primary UI 111 and a secondary unit 1 and secondary unit 2 of secondary UIs 113, the kind and the cooking state of food materials F are displayed and corresponding work instructions are provided to the cooking robot 50.

The user provides a touch input signal to the cleaning UI 115 to remove fry byproducts floating in the fryer 10 (S50). In detail, as shown in FIG. 5, in step S50, a touch input signal is provided to the cleaning ON-UI 115a. In this case, the cleaning mode activates the cleaning ON-UI 115a corresponding to a pending primary UI 111. Then, the cooking robot 50, as shown in FIG. 6, unloads the primary basket 30 out of the fryer 10 (S70). The user removes the fry byproducts floating in the fryer 10 to clean the fryer 10 (S90). For reference, as an embodiment of the present disclosure, it is shown that the cleaning UI 115 corresponding to the primary UI 111 is activated in relation to the primary basket 31, but the present disclosure is not limited thereto and it is possible to clean the fryer 10 into and out of which the secondary basket 33 is loaded and unloaded by activating the cleaning UI 115 corresponding to the secondary UI 113.

Finally, as shown in FIG. 10, a cooking robot 50 control method using the user interface device 100 for the cooking robot 50 according to a second embodiment of the present disclosure relates to a detailed frying process of food materials F and a cleaning process of the fryer 10 using the cooking robot 50.

First, a touch signal for providing a work instruction to the cooking robot 50 is input through the touch screen 130 (S100). In touch signal input in step S100, a user inputs a touch input signal to at least any one of the primary UI 111 and the secondary UI 113 created on the user interface device 100. For example, a touch input signal is provided to any one of the primary UI 111 and the secondary UI 113, a touch input signal is provided to the primary UI 111 and the secondary UI 113, a touch input signal is provided to a plurality of secondary UIs 113, or a touch input signal is provided to at least any one of a plurality of secondary UIs 113. In the second embodiment of the present disclosure, the primary UI 111 and the secondary UI 113 are both activated or the secondary UI 113 is activated.

In accordance with the user's touch input signal, a cooking state is displayed and a work instruction of the cooking robot 50 is created (S300). As shown in FIG. 7, when a user inputs a touch signal to a secondary unit 2 and secondary unit 3 of secondary UIs 113, the kind and the cooking state of food materials F are displayed and corresponding work instructions are provided to the cooking robot 50.

The user provides a touch input signal to the assistant UI 113b of the secondary UI 113 (S500). Then, the cooking robot 50, as shown in FIG. 8, performs an operation of shaking the secondary basket 33 left, right, up, and down in the figure such that oil is provided at uniform temperature to the food materials F. Since the cooking robot 50 performs an operation of shaking the secondary basket 33, the food materials F can be uniformly cooked.

After cooking is finished, the cleaning mode of the fryer 10 is performed. In this case, the cleaning mode of the fryer 10 may be set for each frying process or for a plurality of frying processes. In an embodiment of the present disclosure, it is described that the cleaning mode of the fryer 10 is performed after the frying process, but the present disclosure is not limited thereto.

The user provides a touch input signal to the cleaning UI 115 to remove fry byproducts floating in the fryer 10 (S900). The cleaning mode activates the cleaning ON-UI 115a corresponding to a pending secondary UI 113. The cooking robot 50 unloads the secondary basket 33 out of the fryer 10 (S1100). The user removes the fry byproducts floating in the fryer 10 to clean the fryer 10 (S1300).

Accordingly, since not only UIs for frying, but the cleaning UI cleaning a fryer are provided to the user interface device that provides work instructions to the cooking robot, it is possible to reduce the takt time of the frying process of food materials.

Further, since the user interface device that provides work instructions to the cooking robot is provided with not only UIs for frying, but a UI performing an operation making the cooking robot shake a basket to uniformly cook food materials during the frying process, it is possible to improve reliability in the frying process of food materials.

Although exemplary embodiments of the present disclosure were described above with reference to the accompanying drawings, those skilled in the art would understand that the present disclosure may be implemented in various ways without changing the necessary features or the spirit of the prevent disclosure. Therefore, the embodiments described above are only examples and should not be construed as being limitative in all respects. The scope of the present disclosure is defined by the following claims rather than the above detailed description, and all of changes and modifications obtained from the meaning and range of claims and equivalent concepts should be construed as being included in the scope of the present disclosure.

1. A user interface device for a cooking robot that provides work instructions for frying food materials using a basket in a fryer accommodating oil to the cooking robot while communication with the cooking robot, the user interface device comprising:
a user interface creator creating a primary UI related to a primary frying process of food materials, a secondary UI related to secondary frying process of the food materials, and a cleaning UI related to cleaning of the fryer;
a touch screen displaying the primary UI, the secondary UI, and the cleaning UI and receives a user's touch input signal to execute at least any one of the primary UI, the secondary UI, and the cleaning UI; and
a controller displaying at least any one of a primary frying process state to be displayed on the primary UI, a secondary process state to be displayed on the secondary UI, and a cleaning process state to be displayed on the cleaning UI, and outputting a control signal about a corresponding work instruction of the cooking robot on the basis of a user's touch input signal input to the touch screen.

2. The user interface device of claim 1, wherein the cleaning UI is disposed at each of the primary UI and the secondary UI in correspondence to the primary UI and the secondary UI.

3. The user interface device of claim 2, wherein the cleaning UI comprises:
a cleaning ON-UI providing a cleaning mode for unloading the basket out of the fryer to the cooking robot on the basis of a user's touch input signal; and
a cleaning OFF-UI providing a cleaning stop mode for moving the basket into a frying process ready step to the cooking robot on the basis of a user's touch input signal.

4. The user interface device of claim 3, wherein when the cleaning ON-UI is activated, a user removes floats floating in the fryer.

5. The user interface device of claim 1, wherein the secondary UI comprises:
a main UI displaying the kind of food materials and a frying time state on the basis of a user's touch input signal; and
an assistant UI making the cooking robot shake the basket in a frying process of food materials on the basis of a user's touch input signal.

6. The user interface device of claim 5, wherein when the assistant UI is activated, the cooking robot performs an operation of shaking the basket in the fryer so that uniform temperature of oil is provided to food materials.

7. The user interface device of claim 5, wherein a plurality of secondary UIs is created and displayed on the touch screen, and
the secondary basket is sequentially shaken in a secondary frying process of food materials in accordance with the activation order of the plurality of assistant UIs.

8. A cooking robot control method using a user interface device for a cooking robot, the cooking robot control method comprising:
(a) a step of providing a touch input signal by a user to at least any one of a primary UI and a secondary UI created in the user interface device for a cooking robot;
(b) a step of displaying a state of at least any one of the primary UI and the secondary UI on the user interface device for a cooking robot and creating a corresponding work instruction of the cooking robot on the basis of a user's touch input signal in the step (a);
(c) a step in which the user provides a touch input signal to a cleaning UI created on the user interface device for a cooking robot after the step (b) is finished; and
(d) a step in which the cooking robot unloads a basket out of a fryer so that the user removes floats floating in the fryer in accordance with the step (c).

9. The cooking robot control method of claim 8, wherein the cleaning UI comprises:
a cleaning ON-UI providing a cleaning mode for unloading the basket out of the fryer to the cooking robot on the basis of a user's touch input signal; and
a cleaning OFF-UI providing a cleaning stop mode for moving the basket into a frying process ready step to the cooking robot on the basis of a user's touch input signal.

10. The cooking robot control method of claim 8, wherein the cleaning UI is disposed in relation to the primary UI and the secondary UI in correspondence to the primary UI and the secondary UI.

11. The cooking robot control method of claim 8, wherein the secondary UI comprises a main UI displaying the kind of food materials and a frying time state and an assistant UI making the cooking robot shake the basket in a frying process of food materials, and when the user provides a touch input signal to the assistant UI after the user provides a touch input signal to the main UI in the step (a), the cooking robot provides uniform temperature of oil to food materials by shaking the basket accommodating the food materials.

12. The cooking robot control method of claim 11, wherein a plurality of secondary UIs is created and the cooking robot sequentially shakes the corresponding secondary basket in a secondary frying process of food materials in accordance with the activation order of the plurality of assistant UIs.
